(19) United States
(12) Patent Application Publication
(10) Pub. No.: US 2015/0339836 A1
(43) Pub. Date: Nov. 26, 2015

(54) Game Engine Book Applications

(71) Applicant: Karen Elizabeth Blake, Bakersfield, CA (US)

(72) Inventor: Karen Elizabeth Blake, Bakersfield, CA (US)

(21) Appl. No.: 14/120,480

(22) Filed: May 21, 2014

(51) Int. Cl. G06T 11/60

(52) U.S. Cl. CPC G06T 11/60; G06T 2207/30176

(57) ABSTRACT

Developing a new interactive publishing format which uses game engines to publish material such as books, stories, articles, and papers, became necessary to expound on concepts introduced in the literature by using the physics and rendering engines. The game engine book application, Physics on the River, was developed to demonstrate how to incorporate game controls into the storyline. In addition, animation and a game module were embedded into the application and accessed through links for the reader to learn more about concepts introduced within the story. Other assets, such as voice, music, and sound effects, were created for the book application. Publishing conventions were established. Using a game engine also allows for porting the application for a multiple of mobile devices, as well as stand-alone and web-based versions.

### RELATED APPLICATIONS

U.S. application No.: 61/825,827

Filing Date: May 21, 2013

Name of Applicant: Karen Elizabeth Blake

Title of Invention: Game Engine Book Applications

Relationship of Prior Application: Provisional Patent.

### FEDERALLY SPONSORED RESEARCH AND DEVELOPMENT

This invention is not part of any federally sponsored research and development program.

### COMPUTER PROGRAM LISTING APPENDIX

Unity 3d was selected as the game engine to build the book application. The software is available at http://unity3d.com to view the project files.

1. UnityProject.zip (Project files)

2. GEBookApp.zip (Mac stand-alone game engine book application)

### BACKGROUND OF THE INVENTION

The technical field is digital publishing using game engines.

Understanding game engines and current digital publishing formats is necessary to appreciate the novel use of game engines for publishing, and the practical application game engine book applications when expounding on the concepts introduced in the published material.

The Wikipedia definition of game engine is as follows: “A game engine is a software framework designed and developed for video games . . . The core functionality typically provided by a game engine includes a rendering engine (”renderer“) for 2D or 3D graphics, a physics engine or collision detection (and collision response), sound, scripting, animation, artificial intelligence, networking, streaming, memory management, threading, localization support, and a scene graph. The process of game development is often economized, in large part, by reusing/adapting the same game engine to create different games, or to make it easier to “port” games to multiple platforms.”

Current digital publishing formats are eBooks, enhanced eBooks, and interactive eBook applications. Simple eBooks are limited to flipping pages, searching content, or highlighting words. Font size can also be increased in Simple eBooks. Enhanced eBooks integrate video, audio, and interactivity. Interactive eBook apps allow readers to interact with the storyline by using sight, sound, and touch. Examples include interactive images, pop-ups, graphs bars and charts, jump and push links, guided tours and hotspots, slideshows, and video/audio. Interaction is created through the use of CSS and HTML5. The above information can be found on the following website: www.bestinteractiveebooks.com/2012/04/interactive-ebook-apps-the-reinvention-of-reading-and-interactivity.

Software systems which format HTML, CSS, XML, and images into a graphical representation of a document are referred to as web browser engines. More information can be found at: https://en.wikipedia.org/wiki/Web_browser_engine.

### BRIEF SUMMARY OF THE INVENTION

Developing a new publishing platform became necessary to expound on concepts introduced in my story, Physics on the River, which was done by capitalizing on game engine technology, particularly, but not limited to, the physics and rendering engines built into game engines. Using game engine technology was necessary because I could not find a publisher that could accommodate my vision. The recognition of this need and an overview of the creation process will be discussed.

The development of the game engine book application, Physics on the River, came from years of contemplating how to improve science education, and what was effective with my own children. The best way to present science concepts is to start with what the reader knows and to build from this base. The base is presented in story form, hence the story Physics on the River, which is about a family white water trip. Two science concepts were selected from the story. I developed the hydrology cycle module (link on page 7) as a visual learning tool. The wave on page 20 was designed to be more interactive. It offers an opportunity within the story to change with the speed of the wave to see how far the second rafter is thrown off the boat. The Do the Wave module, which has a link on the page, explains the Law of Momentum, and provides the opportunity for the reader to compare speeds of the masses involved as they manipulate the variables and then start the wave action. The module also has links to resources (hands-on activities) outside of the application.

Publishing the game engine book application included creating the assets and developing the platform. The process for creating the assets used in the application and the structure of the application follows. Platform development is covered in the Master Flow Chart with Brief Description and Detailed Description of the Invention section.

The steps involved in creating the assets include: 1) selecting a story, 2) selecting concepts introduced in the story on which to expound on, 3) creating a storyboard, 4) creating illustrations, 5) creating text files, 6) creating the audio with a reader, 7) creating the sound effects, 8) creating a music track, and 9) developing support material for the concept to be embedded or linked in the application.

### BRIEF DESCRIPTION

Master Flow Chart

### DETAILED DESCRIPTION OF THE INVENTION

The structure of the application will be described in three parts: front matter, story pages, and concept components. The concept components for the game engine book application come from the story, Physics on the River. The first is an animation involving the hydrology cycle, and the second is a module on Newton's Law of Momentum, with an explanation and a collision game. As new stories are published, the concept components will change, but will use the game engine to expound on the concepts introduced.
Front Matter:
   Flash Screen
   Title Page
      Start Button
      Option Button
         Master Volume (slide bar)
         Music Volume (slide bar)
         Voice Volume (slide bar)
         Effects Volume (slide bar)
         Show Subtitles (Enabled Button)
         Show Page Controls (Enabled Button)
         Font Size (slide bar)
         Credits
         Back Button
Story Pages:
   Pages without Concept Links
      Option Button
      Back Arrow
      Forward Arrow
      Swipe Action
      Page Menu Bar (fades after a second)
   Page 7 with Hydrology Cycle Animation Link
      Option Button
      Back Arrow
      Forward Arrow
      Swipe Action
      Page Menu Bar (fades after a second)
      Hydrology Cycle Button (Animation)
   Page 20 with Wave Slide Bar and Do the Wave Module Link
      Option Button
      Back Arrow
      Forward Arrow
      Swipe Action
      Page Menu Bar (fades after a second)
      Start Button (activates wave)
      Wave Slide Bar (increases speed of the wave that hits the boat and increases the distance the man is thrown overboard)
      Do the Wave Button (embedded module)
Concept Components:
   Hydrology Cycle Animation
      Option Button
      Swipe Action
      Returns to page after Animation ends
   Do the Wave Module
      Back to Story Button
      Momentum (pdf with explanation and mathematical formula)
         Swipe Action
         Back Button
      Hands-On Activities (link to website with activities related to science concepts)
      Start Button (Do the Wave Collision Game)
         Do the Wave Collision Game
            Start Button
            Wave Slide Bar
            Mass 1 Slide Bar
            Mass 2 Slide Bar
            Travel Time (Displays Calculated Value)
            Back Button

The use of game engines provides the capability to port the book application to multiple platforms such as native iOS, Android, web-based and stand-alone versions.

I claim:

1. A new interactive publishing format which uses game engines to publish material such as books, stories, articles, and papers.

2. A new interactive publishing format which uses game engines to publish material such as books, stories, articles, and papers, for mobile devices, stand-alone computer versions and web-based versions.

3. A new interactive publishing format which uses game engines to publish material such as books, stories, articles, and papers, for mobile devices such as native iOS and Android devices, as well as stand-alone computer versions and web-based versions.

4. A new interactive publishing format which uses game engines to publish material such as books, stories, articles, and papers, and related supporting materials that expound on the ideas introduced in the book, story, article, or paper, for mobile devices such as native iOS and Android devices, as well as stand-alone computer versions and web-based versions.

5. A new interactive publishing format which uses game engines, to publish material such as books, stories, articles, and papers, and related supporting materials that expound on the ideas introduced in the book, story, article, or paper, that requires a physics engine or rendering engine that is part of the game engine for publishing, for use on mobile devices such as native iOS and Android devices, as well as stand-alone computer versions and web-based versions.
